(19) United States
(12) Patent Application Publication
(10) Pub. No.: US 2004/0135299 A1
(43) Pub. Date: Jul. 15, 2004

(54) Fluid filled elastic mount

(75) Inventor: Naohito Kuwayama, Nagoya-shi (JP)

Correspondence Address: BEYER WEAVER & THOMAS LLP, P.O. BOX 778, BERKELEY, CA, 94704-0778, US

(73) Assignee: TOKAI RUBBER INDUSTRIES, LTD.

(21) Appl. No.: 10/745,185

(22) Filed: Dec. 22, 2003

(30) Foreign Application Priority Data
Dec. 27, 2002 (JP) 2002-380680

(51) Int. Cl. F16M 1/00

(52) U.S. Cl. 267/140.4

(57) ABSTRACT

A fluid filled elastic mount including a rubber elastic body disposed between and integrally connecting coaxial main rod member and outer sleeve member at their first ends. A diaphragm is also disposed between the main rod member and outer sleeve member at their second ends to form between itself and the rubber elastic body a fluid chamber that is divided by an annular partition member held with its outer peripheral edge press fit against the outer sleeve member into a primary fluid chamber and an auxiliary fluid chamber, while forming an orifice passage between its inner surface and the main rod member, for permitting a communication between the primary and auxiliary fluid chamber. The diaphragm has a thick walled portion of annular disk shape, and thin walled portions formed extending circumferentially about an outer peripheral edge of the thick walled portion while covering a smaller range than the thick walled portion.

### INCORPORATED BY REFERENCE

The disclosure of Japanese Patent Application No. 2002-380680 filed on Dec. 27, 2002 including the specification, drawings and abstract is incorporated herein by reference in its entirety.

### BACKGROUND OF THE INVENTION

1. Field of the Invention

The present invention relates to a fluid-filled elastic mount, suitable for use as a differential mount, a member mount or other mounts in an automotive vehicles, for example.

2. Description of the Related Art

Fluid filled elastic mounts for use as automotive differential mounts or member mounts are known in the art, as taught in Citation 1. As illustrated in FIGS. 5 and 6, for example, a fluid filled elastic mount of this kind typically comprises: a main rod member 101; an outer sleeve member 102 concentrically disposed about the main rod member 101 with a given distance therebetween; a rubber elastic body 103 disposed between one end of the main rod member 101 and the corresponding one end of the outer sleeve member 102 for integrally connecting the two together; a diaphragm 104 of annular configuration whose inner peripheral edge is held press fit against an outer circumference of the other end of the main rod member 101 and whose outer peripheral edge is held press fit against an inner circumference of the other end of the outer sleeve member 102, the diaphragm cooperating with the rubber elastic body 103 to form therebetween a fluid chamber filled with a fluid L; and an annular partition member 105 whose outer peripheral edge is held press fit against the inner circumference of the outer sleeve member 102, and dividing the fluid chamber into a primary fluid chamber 151 and an auxiliary fluid chamber 152, while forming an orifice passage 153 between its inner edge face and main rod member 101 for permitting a fluid communication between the primary fluid chamber 151 and the auxiliary fluid chamber 152.

The fluid filled elastic mount is installed with the main rod member 101 fastened, by means of a mounting bolt and nut, etc. (not shown), to either of two members to be connected together in a vibration damping fashion, and with the outer sleeve member 102 press fit and secured into a mounting bore provided on the other of the two members, so that the axis of the elastic mount is aligned with the direction of load input (principal vibration input direction).

When vibration in the high frequency range is input to the fluid filled elastic mount, the rubber elastic body 103 undergoes elastic deformation, effectively absorbing the vibration. When vibration in the low frequency range is input, vibration is effectively absorbed with the help of flows or resonance of the fluid L flowing through the orifice passage 153 in association with change in volume in the primary fluid chamber 151 and the auxiliary fluid chamber 152.

CITATION 1

JP-A-2-275129

In the conventional fluid filled elastic mount described hereinabove, the annular diaphragm 104, which is provided in order to absorb fluid pressure of the fluid L flowing into the auxiliary fluid chamber 152, has a pair of thick walled portions 141 and a pair of thin walled portions 142. The thick walled portions 141 are disposed in a small area of two sites that are axially symmetric locations. The thin walled portions 142 are of arcuate configuration, and are disposed in a large area of two sites to either side of each thick walled portion 141 in the circumferential direction. More specifically, the diaphragm 104 is formed at each thin walled portion 142 with (i) an inner recess 143 extending in arc configuration, situated at the inner peripheral edge, and open in a surface on the auxiliary fluid chamber 152 side, and (ii) an outer recess 144 extending in arc configuration, situated at the outer peripheral edge, and open in a surface on the side remote or opposite from the auxiliary fluid chamber 152. With this arrangement, each thin walled portion 142 is effectively thinned. The thin walled portions 142 formed in this manner have considerable free length in the diametric direction and can readily undergo elastic deformation.

However, since the fluid pressure of the fluid L sealed within the fluid chamber is above atmospheric pressure, the diaphragm 104 is attached at the outset with the thin walled portions 142 distending outwardly. Thus, when vibration (load) is subsequently input in the axial direction to the fluid filled elastic mount, and causes repeated distension and contraction of the diaphragm 104 in association with changes in pressure of the fluid L, the diaphragm 104 may suffer from strain concentrations in weaker portions of the thin walled portions 142 that undergo appreciable deformation, or wear of distended thin walled portions 142 through contact with outer sleeve member 102. This tends to result in cracking in these portions, creating the problem of low durability.

### SUMMARY OF THE INVENTION

It is therefore one object of this invention to provide a fluid filled elastic mount that exhibits enhanced durability.

The above and/or optional objects of this invention may be attained according to at least one of the following modes of the invention. Each of these modes of the invention is numbered like the appended claims and depending from the other mode or modes, where appropriate, to indicate possible combinations of elements or technical features of the invention. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a fluid filled elastic mount including: a main rod member; an outer sleeve member concentrically disposed about the main rod member with a given distance therebetween; a rubber elastic body disposed between and elastically connecting one of axial end portions of the main rod member and one of axial end portions of the outer sleeve member; a rubber elastic diaphragm member of approximately annular configuration disposed between and elastically connecting an other one of axial end portions of the main rod member and an other one of axial end portions of the outer sleeve member, the diaphragm member extending between the main rod member and the outer sleeve member in a direction perpendicular to an axial direction of the main rod member, and cooperating with the first rubber elastic body to define therebetween a fluid chamber filled with a non-compressible fluid; and an annular partition member whose outer peripheral portion is held press fit against an axially intermediate portion of an inner circumferential surface of the outer sleeve member so as to divide the fluid chamber into a primary fluid chamber partially defined by the first rubber elastic body and an auxiliary fluid chamber partially defined by the diaphragm member, and whose inner peripheral portion cooperates with the main rod member to define therebetween an orifice passage for permitting a fluid communication between the primary fluid chamber and auxiliary fluid chamber; wherein the diaphragm member is formed with at least one circumferentially extending recess situated at a radially outer portion thereof, and open in and axially extending from at least one of axially opposite surfaces thereof, so as to provide a thin walled portion at the radially outer portion thereof and a thick walled portion of approximately annular configuration at a radially inner portion thereof such that the thin walled portion occupies a smaller range of the diaphragm member than do the thick walled portion.

In the fluid filled elastic mount according to the present invention, the diaphragm member has a thick walled portion occupying a larger range than the thin walled portions. Thus, the diaphragm as a whole has increased spring rigidity, thereby eliminating or minimizing the risk of the diaphragm distending outwardly at the outset due to the fluid pressure of fluid sealed within the fluid chamber. Therefore, the risk of diaphragm wear due to contact with the outer sleeve member etc. during repeated distension and contraction in association with changes in pressure of fluid when vibration is input may be reduced. Stress concentration in the thin walled portions when the diaphragm undergoes elastic deformation may be minimized as well.

Accordingly, the fluid filled elastic mount according to this mode of the invention is capable of eliminating or minimizing the risk of cracking of the diaphragm, and enhancing its durability appreciably.

Since the diaphragm member has the thick walled portion disposed along the inside circumference of the diaphragm at a location opposite the orifice passage, and the thin walled portion disposed outward of the thick walled portion, the thick walled portion exhibits a piston function, and can thereby accelerate the flow of fluid so that high vibration damping characteristics are achieved.

Preferably, the thin walled portion has an expansion spring stiffness smaller than those of the thick walled portion and the first rubber elastic body.

Yet preferably, an area ratio of the thick walled portion to the thin walled portion as measured in axial cross section is held within a range 4:1 to 5:1.

Still preferably, a radial dimension ration of the thick walled portion to the thin walled portion as measured in axial cross section is held within a range 2:1 to 4:1, more preferably 3:1.

It should be noted that the recess may have a variety of configurations. For instance, the recess may extend continuously over the entire circumference of the diaphragm member, or alternatively may be provided at a plurality of circumferential portions with a given circumferential length, while being spaced away from one another.

Namely, through suitable design of the depth, dimensions, and shape of the provided recess, it is a simple matter to produce the thin walled portion of any desired thickness, dimensions, and shape. The recess may be provided only on either the front or back face of the diaphragm, or on both faces so as to be juxtaposed thereon. By providing the recess on a different face or varying the depth of the recess, the location at which the thin walled portion connects to the thick walled portion can be established freely.

A second mode of the invention provides a fluid filled elastic mount according to the first mode, wherein the at least one recess is open in one of axially opposite surfaces of the second rubber elastic body, which is remote from the auxiliary fluid chamber. With this arrangement, when distending outwardly, the thin walled portion is likely to be held within the diaphragm member, thus further effectively eliminating or minimizing the conventional problem of wear of the diaphragm due to contact with the outer sleeve member.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is an elevational view in axial cross section of a fluid filled elastic mount constructed according to one embodiment of the invention, taken along line 1-1 of FIG. 2;

FIG. 2 is a bottom plane view of the fluid filled elastic mount of FIG. 1;

FIG. 3 is an elevational view in axial cross section of a fluid filled elastic mount constructed according to another embodiment of the invention, taken along line 3-3 of FIG. 4;

FIG. 4 is a bottom plane view of the fluid filled elastic mount of FIG. 3;

FIG. 5 is an elevational view in axial cross section of a conventional fluid filled elastic mount, taken along line 5-5 of FIG. 6; and

FIG. 6 is a bottom plane view of the conventional fluid filled elastic mount of FIG. 5.

### DETAILED DESCRIPTION OF PREFERRED EMBODIMENTS

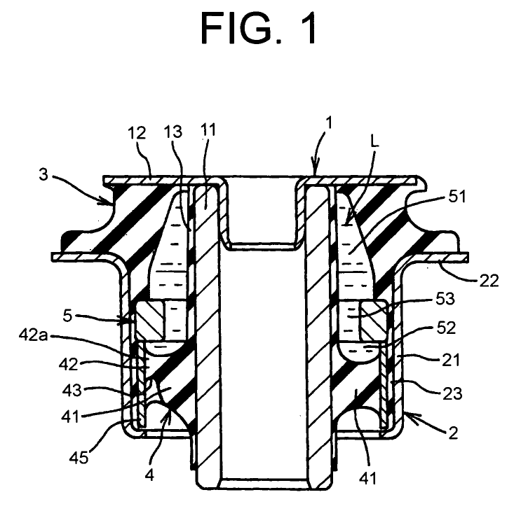

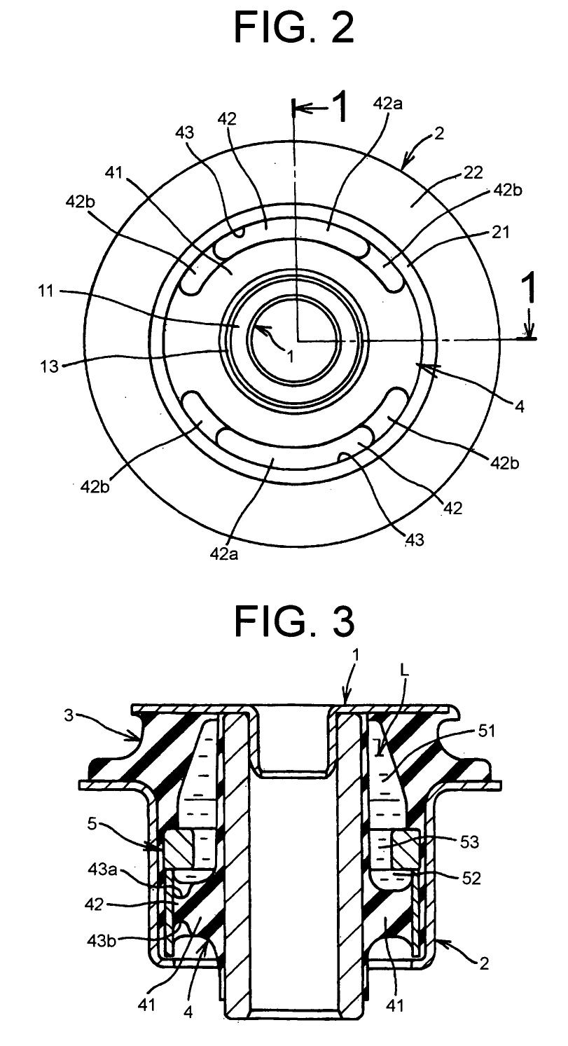

Referring first to FIGS. 1 and 2, shown is a fluid filled elastic mount constructed according to a first embodiment of the invention. The present fluid filled elastic mount includes: a main rod member 1 having a first tubular portion 11 and a first flange 12 disposed on a first end of the first tubular portion 11; an outer sleeve member 2 coaxially disposed about the main rod member 1 with a given distance therebetween, and having a second tubular portion 21 as well as a second flange 22 disposed on a first end of the second tubular portion 21; a rubber elastic body 3 disposed between the first flange 12 and the second flange 22, integrally connecting the two together; and a rubber elastic diaphragm member in the form of a diaphragm 4 of annular configuration whose inner peripheral edge is held press fit against an outer circumferential surface at the other end of the first tubular portion 11 and whose outer peripheral edge is held press fit against an inner circumferential surface at the other end of the second tubular portion 21 so as to form a fluid chamber between itself and the rubber elastic body 3. The diaphragm 4 has a thick walled portion 41 and thin walled portions 42. The fluid filled elastic mount further includes an annular partition member 5 whose outer peripheral portion is held press fit against the inner circumferential surface of the second tubular portion 21 at axially intermediate portion thereof, and divide the fluid chamber into a primary fluid chamber 51 and an auxiliary fluid chamber 52, while forming an orifice passage 53 for permitting a fluid communication between the primary fluid chamber 51 and the auxiliary fluid chamber 52.

The main rod member 1 comprises the first tubular portion 11 formed in tubular configuration, and the annular first flange 12 secured fitting against an inner circumferential surface thereof at a first end of the first tubular portion 11, and extending diametrically outward along one end face of the first tubular portion 11. The first tubular portion 11 and the first flange 12 are made of ferric or aluminum metal. An outer circumferential surface of the first tubular portion 11 is coated by a rubber coating layer 13 integrally formed with the diaphragm 14.

The outer sleeve member 2 comprises the second tubular portion 21 formed in tubular configuration, and the annular second flange 22 extending diametrically outward from one end of the second tubular portion 21, and is integrally formed of ferric or aluminum metal. The second flange 22 has inside diameter larger, by a predetermined dimension, than the outside diameter of the first tubular portion 11 of the main rod member 1, and has length shorter, by a predetermined dimension, than the first tubular portion 11. An inner circumferential surface of the second tubular portion 21 is coated by a rubber coating layer 23 integrally formed with the rubber elastic body 3. This outer sleeve member 2 is disposed with the second tubular portion 21 situated some distance diametrically outward from the first tubular portion 11, and concentric therewith, and with the second flange 22 facing the first flange 12 across a gap of some distance in the axial direction.

The rubber elastic body 3 has a thick walled, generally cylindrical configuration, produced by integral vulcanization molding of a rubber material together with the first flange 12 of the main rod member 1, and the outer sleeve member 2. Namely, the rubber elastic body 3, the first flange 12 and the outer sleeve member 2 cooperate to provide a first integral vulcanized product. The rubber elastic body 3 is bonded by the vulcanization at one end thereof to an inside face of the first flange 12, interposed between the first flange 12 and the second flange 22. In this way, the rubber elastic body 3 is arranged such that when vibration (load) is input in the axial direction with respect to the main rod member 1 and outer sleeve member 2, it provides elastic support, mainly by means of being compressed. An inner circumferential surface of the rubber elastic body 3 slopes so that diameter increases gradually going from a first end to the other end, with the other end of the rubber elastic body 3 connecting with the rubber coating layer 23 that covers the inner circumferential surface of the second tubular portion 21.

The diaphragm 4 has an annular configuration produced by integral vulcanization molding of a rubber material with the first tubular portion 11 of the main rod member 1, and a cylindrical retaining member 45 made of metal. Namely, the diaphragm 4, the first tubular portion 11 and the retaining member 45 cooperate to provide a second integral vulcanized product. An inner circumferential surface of the diaphragm 4 is bonded by the vulcanization to the outer circumferential surface at the other end (end opposite first flange 12) of the first tubular portion 11. The two axial ends on the inner peripheral side of the diaphragm 4 connect with the rubber coating layer 13 that coats the outer circumferential surface of the first tubular portion 11. An outer circumferential surface of the diaphragm 4 is bonded by the vulcanization to an inner circumferential surface of the retaining member 45. Thus, the diaphragm 4 extends between the main rod member 1 and the outer sleeve member 2 in a direction perpendicular to an axial direction of the main rod member 1. The retaining member 45 is retained press-fit against the inner circumferential surface of the other end (end opposite second flange 22) of the rubber coating layer 23 that coats the inner peripheral face of the second tubular portion 21. With this arrangement, a sealed fluid chamber is formed between the diaphragm 4 and the rubber elastic body 2. Within this fluid chamber is sealed a noncompressible fluid L such as water, an alkylene glycol, and silicone oil. The filling of the fluid chamber with the non-compressible fluid may be accomplished by assembling the first integral vulcanized product with the second integral vulcanized product in the axial direction within a mass of the fluid. When assembling the first and second integral vulcanized products together in the axial direction, an excess amount of fluid is effectively discharged to the outside of the fluid chamber through a gap formed between the retaining member and the rubber coating layer 23 on adhered to the inner circumferential surface of the outer sleeve member 2. Then, a drawing operation is performed on the second tubular portion 21 of the outer sleeve member 2 to reduce the diameter of the second tubular portion 21, so that the second tubular portion 21 is fluid-tightly pressed onto the retaining member 45 with the rubber coating layer 23 compressed therebetween.

The diaphragm 4 has the thick walled portion 41 of thick annular disk configuration, and a pair of thin walled portions 42 of arcuate configuration extending in the circumferential direction along the outer peripheral edge of the thick walled portion 41 at two locations that are situated in axial symmetry, diametrically outward from the thick walled portion 41. The thin walled portions 42 are formed on an face opposite the fluid chamber, by producing recesses 43, 43 that extend with arc, preferably semi circular configuration in cross section, in the circumferential direction along an outer peripheral edge of the thick walled portion 41. The two recesses 43 are situated at respective locations at the radially outer portion of the diaphragm 4. The locations are diametrically opposite to each other with the thick walled portion on the radially inner portion of the diaphragm 4 interposed therebetween. Thus, each thin walled portion 42 is disposed at the end of the fluid chamber side in the thickness direction of the thick walled portion 41. The circumferential center portion of each thin walled portion 42 (portion covering an angular range of approximately 45°) is formed with generally uniform thickness about equal to the depth of the recesses 43. Opposite ends 42b (each portion covering an angular range of approximately 30°) in the circumferential direction of each thin walled portion 42 are sloped so as to gradually increase in thickness closer to opposite edges. The diametrical width or a radial thickness of each thin walled portion 42 is equivalent to about 30% of the width of the thick walled portion 41 situated diametrically inward of each thin walled portion 42.

The diaphragm 4 is designed with an area ratio of the thick walled portion 41 to thin walled portion 42 as measured in axial cross section as shown in FIG. 1 of 4:1 to 5:1, and/or a radial thickness ratio of the thick walled portion to the thin walled portion as measured in the axial cross section of 2:1 to 4:1, preferably 3:1. The greater area of the thick walled portion 41 relative to the thin walled portion 42 providing greater spring rigidity to the diaphragm 4 overall. Thus, the problem of the diaphragm 4 distending outwardly from the outset due to pressure of the fluid L sealed in the fluid chamber may be eliminated. It is also noted that the thin walled portion 42 has an expansion spring stiffness smaller than those of the thick walled portion and the first rubber elastic body.

The partition member 5 is of annular form having rectangular cross section, made of ferric metal. This partition member 5 has an inside diameter larger by a predetermined dimension than the outside diameter of the first tubular portion 11, and an outside diameter smaller by a predetermined dimension than the inside diameter of the second tubular portion 21. This partition member 5 is held with its outer peripheral portion press fit against an inner circumferential surface of the rubber coating layer 23 that coats the inner circumferential surface of the second tubular portion 21. That is, the partition member 5 is arranged at a location adjacent to the diaphragm 4 and retaining member 45 in the generally central portion in the axial direction of the second tubular portion 21. Thus, partition member 5 divides the fluid chamber into the primary fluid chamber 51 formed on the rubber elastic body 2 side, and the auxiliary fluid chamber 52 formed on the diaphragm 4 side. In this regards, the lower end portion of the second tubular portion 21 of the outer sleeve member 2 is bent radially inwardly and caulked against onto the lower end face of the retaining member 45 so that the partition member 5 is gripped by and fixedly positioned between the rubber elastic body 3 and the retaining member 45 in the axial direction.

A gap of predetermined dimensions formed between an inner peripheral portion of the partition member 5 and the rubber coating layer 13 that coats the outer peripheral face of the first tubular portion 11 constitutes the annular orifice passage 53 by which the primary fluid chamber 51 and auxiliary fluid chamber 52 communicate with each other. That is, this orifice passage 53 is disposed facing the thick walled portion 41 of the diaphragm 4.

The fluid filled elastic mount having the construction described above is installed with the first tubular portion 11 of the main rod member 1 fastened, by means of a mounting bolt and nut or the like (not shown), to either of two members to be connected in a vibration damping fashion, and with the second tubular portion 21 of the outer sleeve member 2 press fit and secured into a mounting hole provided on the other member, so that the axis of the elastic mount is aligned with the direction of load input (principal vibration input direction.

When vibration in a high frequency range is input to this fluid filled elastic mount, the rubber elastic body 3 undergoes elastic deformation, effectively absorbing the vibration. When vibration in the low frequency range is input, flows or resonance of the liquid L flowing through the orifice passage 53 in association with change in volume in primary fluid chamber 51 and the auxiliary fluid chamber 52 effectively absorbs the vibration.

It should be appreciated that the diaphragm 4 has a thick walled portion 41 disposed at the inner circumferential side of the diaphragm 4 at a location opposite to the orifice passage 53, and the thin walled portions 42 disposed to the outside of the thick walled portion 41. This arrangement permits the thick walled portion 41 to exhibit a piston function. The flow of the fluid L through the orifice passage 53 is accelerated thereby, so that excellent vibration damping characteristics are achieved. Additionally, the diaphragm 4 has a thick walled portion 41 covering a greater area than the thin walled portions 42, providing greater spring rigidity overall. This arrangement makes it possible to eliminate or minimize conventionally experienced problems, i.e., the risk of wear due to contact with the outer sleeve member 2 or the like during repeated distension and contraction in association with changes in pressure of the fluid L when vibration is input may be reduced, and stress concentration in the thin walled portions 42 when it undergoes elastic deformation. Thus, the risk of cracking of the diaphragm 4 can be avoided, and durability markedly improved.

According to the fluid filled elastic mount of this embodiment, the diaphragm 4 has the thick walled portion 41 of thick annular disk configuration, and the thin walled portions 42 extending in the circumferential direction along the outer peripheral edge of the thick walled portion 41 and covering a smaller range than the thick walled portion 41. With this arrangement, the risk of cracking of the diaphragm 4 can be avoided, and durability markedly improved.

Additionally, the diaphragm 4 has a thick walled portion 41 disposed at the inner circumferential side of the diaphragm 4 at a location opposite the orifice passage 53, and thin walled portions 42 disposed to the outside of the thick walled portion 41. With this arrangement, the thick walled portion 41 exhibits a piston function, whereby flow of the fluid L through the orifice passage 53 is accelerated thereby, so that high vibration damping characteristics are achieved.

In this embodiment, the thin walled portion 42 is formed by a recess 43 on the surface of the diaphragm 4 on the opposite side from the fluid chamber. Therefore, through suitable design of the depth, dimensions, and shape of the recess 43, it is a simple matter to produce the thin walled portion 42 of any desired thickness, dimensions, and shape.

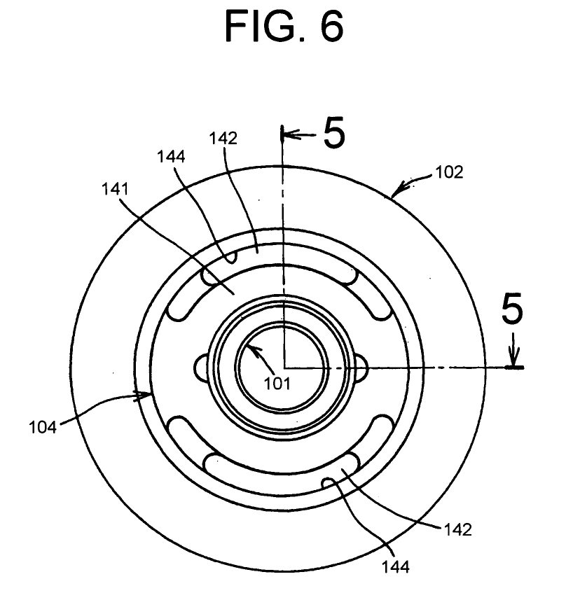

The fluid filled elastic mount of the present embodiment and the conventional fluid filled elastic mount depicted in FIGS. 5 and 6 were subjected to durability tests involving loading in the axial direction. The results showed that whereas with the conventional design, cracking of the diaphragm 104 occurred after 81,000 times loadings, with the present embodiment, cracking of the diaphragm 4 occurred only after 419,000 times loadings. This result evidences that the fluid filled elastic mount of the embodiment has a dramatic improvement in durability, to approximately five times more durability than the conventional design.

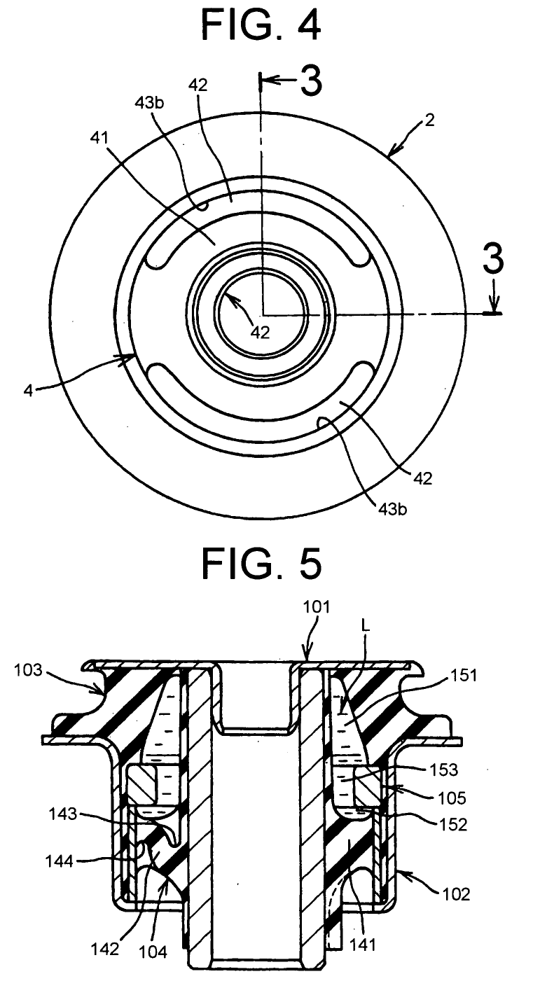

FIG. 3 is a sectional view of a fluid filled elastic mount constructed according to another embodiment of the invention, taken along line 3-3 in FIG. 4. FIG. 4 is a bottom view of the fluid filled elastic mount.

As shown in FIGS. 3 and 4, the fluid filled elastic mount of this embodiment has an arrangement of the main rod member 1, the outer sleeve member 2, the rubber elastic body 3, and the partition member 5 that is completely identical to that in the preceding embodiment, differing only in manner in which the thin walled portion 42 of the diaphragm 4 is formed. Thus, the following description will omit the details of the main rod member 1, the outer sleeve member 2, the rubber elastic body 3, and the partition member 5, focusing instead on the different diaphragm 4.

The diaphragm 4 of this embodiment has a pair of thin walled portions 42 of arcuate configuration extending in the circumferential direction along the outer peripheral edge of the thick walled portion 41 at two locations that are situated in axial symmetry, diametrically outward of the thick walled portion 41. These thin walled portions 42 are formed by producing first recesses 43a disposed on the auxiliary fluid chamber 52 side of diaphragm 4, and second recesses 43b disposed on the opposite side therefrom. The first recesses 43a and the second recesses 43b have the same depth and size. Thus, the thin walled portions 42 are connected to the thick walled portion 41 at the central portion in the thickness direction of the thick walled portion 41. Since the first recesses 43a and the second recesses 43b are formed to the same depth from one end to the other, thickness of each thin walled portion 42 is substantially constant from the one end to the other.

In the present embodiment, the first recesses 43a for forming thin walled portions 42 are provided on the auxiliary fluid chamber 52 side of the diaphragm 4 as well. With this arrangement, the capacity of the auxiliary fluid chamber 52 can be increased, providing an advantage in terms of vibration damping effect based on flow of fluid L.

It is also to be understood that the present invention may be embodied with various other changes, modifications and improvements, which may occur to those skilled in the art, without departing from the spirit and scope of the invention defined in the following claims.

What is claimed is:

1. A fluid filled elastic mount comprising:
a main rod member;
an outer sleeve member concentrically disposed about the main rod member with a given distance therebetween;
a rubber elastic body disposed between and elastically connecting one of axial end portions of the main rod member and one of axial end portions of the outer sleeve member;
a rubber elastic diaphragm member of approximately annular configuration disposed between and elastically connecting an other one of axial end portions of the main rod member and an other one of axial end portions of the outer sleeve member, the diaphragm member extending between the main rod member and the outer sleeve member in a direction perpendicular to an axial direction of the main rod member, and cooperating with the first rubber elastic body to define therebetween a fluid chamber filled with a non-compressible fluid; and
an annular partition member whose outer peripheral portion is held press fit against an axially intermediate portion of an inner circumferential surface of the outer sleeve member so as to divide the fluid chamber into a primary fluid chamber partially defined by the first rubber elastic body and an auxiliary fluid chamber partially defined by the diaphragm member, and whose inner peripheral portion cooperates with the main rod member to define therebetween an orifice passage for permitting a fluid communication between the primary fluid chamber and auxiliary fluid chamber;
wherein the diaphragm member is formed with at least one circumferentially extending recess situated at a radially outer portion thereof, and open in and axially extending from at least one of axially opposite surfaces thereof, so as to provide a thin walled portion at the radially outer portion thereof and a thick walled portion of approximately annular configuration at a radially inner portion thereof such that the thin walled portion occupies a smaller range of the diaphragm member than do the thick walled portion.

2. A fluid filled elastic mount according to claim 1, wherein the at least one recess is open in one of axially opposite surfaces of the second rubber elastic body, which is remote from the auxiliary fluid chamber.

3. A fluid filled elastic mount according to claim 1, wherein the thin walled portion has an expansion spring stiffness smaller than those of the thick walled portion and the first rubber elastic body.

4. A fluid filled elastic mount according to claim 1, wherein an area ratio of the thick walled portion to the thin walled portion as measured in axial cross section is held within a range 4:1 to 5:1.

5. A fluid filled elastic mount according to claim 1, wherein a radial thickness ratio of the thick walled portion to the thin walled portion as measured in axial cross section is held within a range 2:1 to 4:1.

6. A fluid filled elastic mount according to claim 1, wherein the at least one recesses comprises a pair of recesses formed at two locations diametrically opposite to each other with the thick walled portion interposed therebetween, each recess has an axial depth dimension gradually decreases as it goes circumferential opposite ends thereof.

7. A fluid filled elastic mount according to claim 1, wherein the main rod member has a first flange at the one of axial end portions thereof, and the outer sleeve member has a second flange at the one of axial end portions thereof, which is situated opposed to the first flange in the axial direction, while the rubber elastic body is disposed between the first and second flanges so that the rubber elastic body is compressed between the first and second flanges to provide elastic support during vibration input in the axial direction.

8. A fluid filled elastic mount according to claim 1, wherein the at least one recess has an arc configuration in cross section.
